(19) United States
(12) Patent Application Publication
(10) Pub. No.: US 2016/0031370 A1
(43) Pub. Date: Feb. 4, 2016

(54) VEHICLE VISION SYSTEM WITH VIDEO SWITCHING

(71) Applicant: MAGNA ELECTRONICS INC., Auburn Hills, MI (US)

(72) Inventor: Clarence P. McElroy, Grand Blanc, MI (US)

(21) Appl. No.: 14/810,799

(22) Filed: Jul. 28, 2015

Related U.S. Application Data
(60) Provisional application No. 62/030,213, filed on Jul. 29, 2014.

(51) Int. Cl. B60R 1/00; H04N 7/18

(52) U.S. Cl. CPC B60R 1/00; H04N 7/181; B60R 2300/105; B60R 2300/20

(57) ABSTRACT

A vision system of a vehicle includes first and second cameras configured to be disposed at a vehicle so as to have respective fields of view. The first camera generates a first video output of images. The second camera generates a second video output of images. The first and second cameras operate asynchronously. A display is configured to be disposed in the vehicle for viewing by a driver of the vehicle. The display is operable to display video images captured by the first and second cameras. A control is operable to select one of the first and second video outputs for display of respective video images at the display. The control is operable to apply a dark display signal during a synchronizing period when the control switches from use of the first video output to use of the second video output.

### CROSS REFERENCE TO RELATED APPLICATION

The present application claims the filing benefits of U.S. provisional application Ser. No. 62/030,213, filed Jul. 29, 2014, which is hereby incorporated herein by reference in its entirety.

### FIELD OF THE INVENTION

The present invention relates generally to a vehicle vision system for a vehicle and, more particularly, to a vehicle vision system that utilizes two or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a vision system or imaging system for a vehicle that utilizes two or more cameras (preferably two or more CMOS cameras) to capture images of a scene occurring exterior of the vehicle, and includes a display operable to display video images captured by first and second cameras of the vehicle. A control has a switch that is operable to select one of the first and second video outputs of the respective first and second cameras for display of respective video images at the display. The control is operable to apply a dark display signal during a synchronizing period when the switch switches from use of the first video output to use of the second video output.

The cameras operate asynchronously, whereby the first camera may have a first frame timing and the second camera may have a second frame timing different than the first frame timing. The dark display signal may comprise a dark graphic overlay over the video images of the second video output, such that a person viewing the display will see a dark screen during a period of time when the display is synchronizing with the second camera signal, and thus the person viewing the display does not see scrolling or the like of images during the synchronizing period. The control may stop applying the dark display signal following a predetermined time after switching that is sufficient to allow the display to become synchronized with the second camera. The system of the present invention thus provides an enhanced transition from displaying images from one camera to images from another camera, without involvement of the display, whereby the display displays the images (and overlay when applicable) that are communicated to the display via the control and switch or switching module.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention; and

FIG. 2 is a schematic of a switching module of the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle.

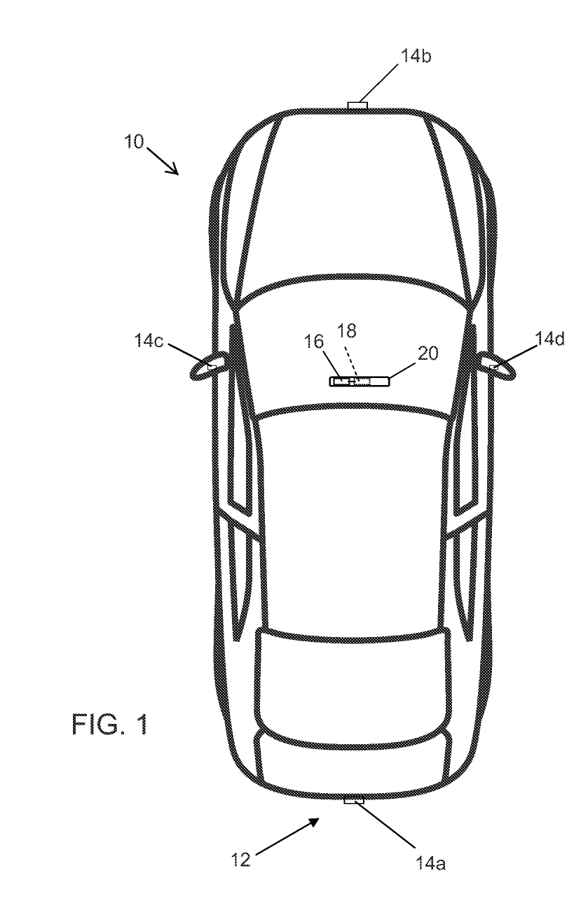

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sidewardly/rearwardly facing camera 14c, 14d at respective sides of the vehicle), which captures images exterior of the vehicle, with the camera having a lens for focusing images at or onto an imaging array or imaging plane or imager of the camera (FIG. 1). The vision system 12 includes a control or electronic control unit (ECU) or processor 18 that is operable to process image data captured by the cameras and may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

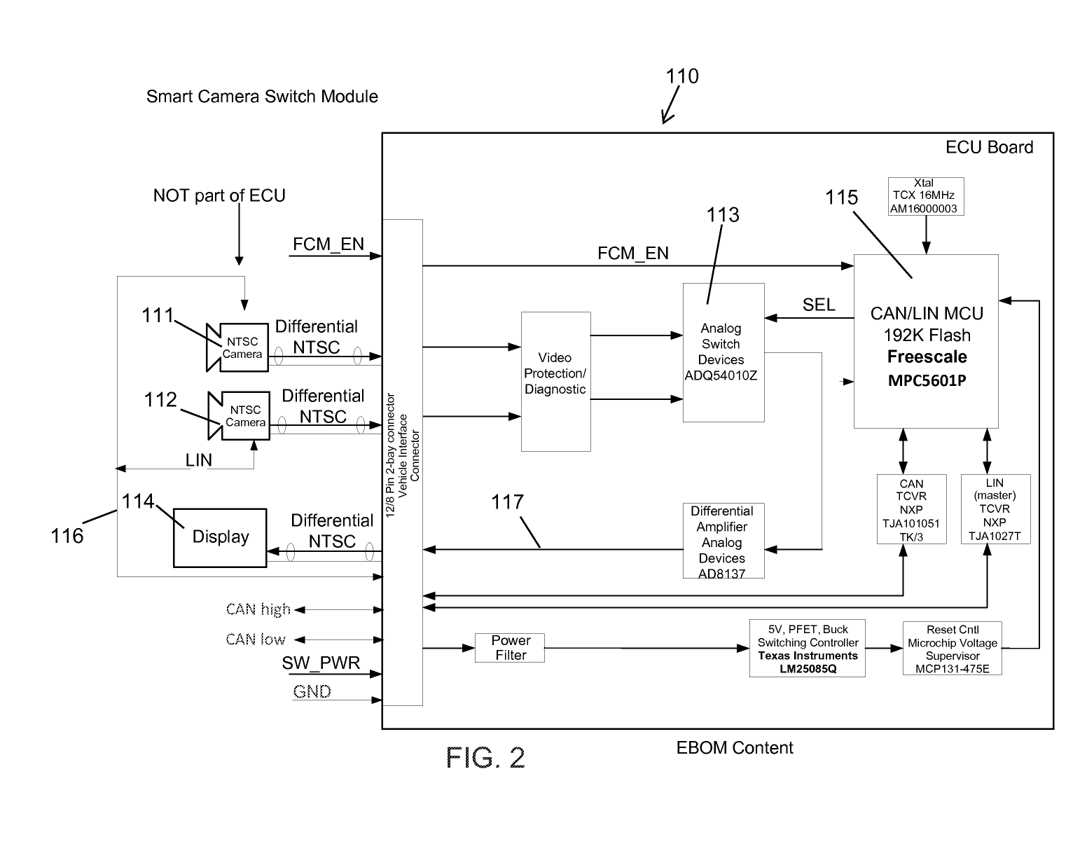

Referring now to FIG. 2, a switch module 110 is used to select the video output of one of two cameras 111, 112 to be shown on an in-vehicle display 114. In such a system, the two cameras 111, 112 run asynchronously. When switching from the first camera 111 to the second camera 112, the switch 113, which is controlled by microcontroller 115, changes the output 117 from one camera to the other. The attached display 114 may show an undesirable artifact of a scrolling image just after switching cameras. The scrolling may be affected by the fact that the cameras are asynchronous, and that the display does not handle changing from one camera that has a first frame timing to a second camera with a different frame timing immediately. Rather, the image of the second camera scrolls until the display is synchronized with the second camera.

A traditional approach to eliminate such visual artifacts is to have the display blank out the screen during the switching. However, this solution does not seem to be possible with some displays.

The present invention provides a system that minimizes the visual scrolling effect by showing an all-black screen during and immediately after the switching without involvement of the display. This is achieved by having the microcontroller 115 of the switch module command the second camera 112 through a serial data message on the serial data bus 116 to display an all-black image during and just after switching. The all-black image may be generated through a low-power mode in the camera 112 or by overlaying an all-black overlay on top of the camera image of camera 112. When the display receives the all-black image from camera 112 it may be out of synch and scrolling, but being all black the driver will not be able to detect this artifact. After a predetermined time that is sufficient to allow the display 114 to become synchronized with the second camera 112, the microcontroller 115, through the serial data bus 116, instructs the second camera 112 to remove the all-black overlay such that the regular camera image becomes visible.

As a result, the driver will see a short black screen when switching from one camera to the next, but will not see the less desirable scrolling and eventual synchronizing of the second camera as it occurs. This desirable effect can be achieved without involvement of the display.

The overlay applied to the image during the synchronization may be provided via any suitable means, such as by utilizing aspects of the systems described in U.S. Pat. Nos. 8,451,107 and/or 5,670,935, which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580; and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, which are hereby incorporated herein by reference in their entireties.

Optionally, for example, the vision system video display device disposed at or in the interior rearview mirror assembly of the vehicle may utilize aspects of the video mirror display systems described in U.S. Pat. No. 6,690,268; 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252 and/or 6,642,851, and/or U.S. Publication No. US-2012-0162427 and/or International Publication No. WO 2012/051500, which are hereby incorporated herein by reference in their entireties. Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a first camera configured to be disposed at a vehicle so as to have a first field of view, said first camera generating a first video output of image data captured by said first camera;
a second camera configured to be disposed at a vehicle so as to have a second field of view, said second camera generating a second video output of image data captured by said second camera;
wherein said first and second cameras operate asynchronously;
a display configured to be disposed in the vehicle for viewing by a driver of the vehicle, wherein said display is operable to display video images derived from image data captured by said first and second cameras;
a control operable to select one of said first and second video outputs for display of respective video images at said display; and
wherein said control is operable to apply a dark display signal during a synchronizing period when said control switches from use of said first video output for display of video images derived from image data captured by said first camera to use of said second video output for display of video images derived from image data captured by said second camera.

2. The vision system of claim 1, wherein said dark display signal comprises a dark graphic overlay over the video images of said second video output.

3. The vision system of claim 1, wherein said dark display signal is generated via a low-power mode of said second camera.

4. The vision system of claim 1, wherein said first camera has a first frame timing and said second camera has a second frame timing different than said first frame timing.

5. The vision system of claim 1, wherein said control stops applying said dark display signal following a predetermined time after switching that is sufficient to allow said display to become synchronized with said second camera.

6. The vision system of claim 1, wherein said control applies said dark display signal to said second video output signal.

7. The vision system of claim 6, wherein said control applies said dark display signal to said display via a serial data bus of the vehicle.

8. The vision system of claim 1, wherein said first camera comprises a pixelated imaging array having a plurality of photosensing elements and wherein said second camera comprises a pixelated imaging array having a plurality of photosensing elements, and wherein said control has an image processor operable to process image data captured by said first and second cameras.

9. The vision system of claim 1, wherein, when said first camera is disposed at the vehicle, said first field of view of said first camera is exterior of the vehicle and wherein, when said second camera is disposed at the vehicle, said second field of view of said second camera is exterior of the vehicle.

10. The vision system of claim 9, wherein said second field of view of said second camera is rearward of the vehicle.

11. A vision system of a vehicle, said vision system comprising:
a first camera configured to be disposed at a vehicle so as to have a first field of view exterior of the vehicle, said first camera generating a first video output of image data captured by said first camera;
a second camera configured to be disposed at a vehicle so as to have a second field of view exterior of the vehicle, said second camera generating a second video output of image data captured by said second camera;
wherein said first camera comprises a pixelated imaging array having a plurality of photosensing elements and wherein said second camera comprises a pixelated imaging array having a plurality of photosensing elements;
wherein said first and second cameras operate asynchronously;
a display configured to be disposed in the vehicle for viewing by a driver of the vehicle, wherein said display is operable to display video images derived from image data captured by said first and second cameras;
a control operable to select one of said first and second video outputs for display of respective video images at said display;
wherein said control has an image processor operable to process image data captured by said first and second cameras; and
wherein said control is operable to apply a dark display signal during a synchronizing period when said control switches from use of said first video output for display of video images derived from image data captured by said first camera to use of said second video output for display of video images derived from image data captured by said second camera.

12. The vision system of claim 11, wherein said dark display signal comprises a dark graphic overlay over the video images of said second video output.

13. The vision system of claim 11, wherein said dark display signal is generated via a low-power mode of said second camera.

14. The vision system of claim 11, wherein said first camera has a first frame timing and said second camera has a second frame timing different than said first frame timing.

15. The vision system of claim 11, wherein said control stops applying said dark display signal following a predetermined time after switching that is sufficient to allow said display to become synchronized with said second camera.

16. The vision system of claim 11, wherein said control applies said dark display signal to said second video output signal.

17. The vision system of claim 11, wherein said control applies said dark display signal via a serial data bus of the vehicle.

18. A vision system of a vehicle, said vision system comprising:
a first camera configured to be disposed at a vehicle so as to have a first field of view exterior of the vehicle, said first camera generating a first video output of image data captured by said first camera;
a second camera configured to be disposed at a vehicle so as to have a second field of view exterior of the vehicle, said second camera generating a second video output of image data captured by said second camera;
wherein said first camera comprises a pixelated imaging array having a plurality of photosensing elements and wherein said second camera comprises a pixelated imaging array having a plurality of photosensing elements;
wherein said first and second cameras operate asynchronously;
a display configured to be disposed in the vehicle for viewing by a driver of the vehicle, wherein said display is operable to display video images derived from image data captured by said first and second cameras;
a control operable to select one of said first and second video outputs for display of respective video images at said display;
wherein said control has an image processor operable to process image data captured by said first and second cameras;
wherein said control is operable to apply a dark display signal during a synchronizing period when said control switches from use of said first video output for display of video images derived from image data captured by said first camera to use of said second video output for display of video images derived from image data captured by said second camera;
wherein said first camera has a first frame timing and said second camera has a second frame timing different than said first frame timing; and
wherein said control stops applying said dark display signal following a predetermined time after switching that is sufficient to allow said display to become synchronized with said second camera.

19. The vision system of claim 18, wherein said dark display signal comprises a dark graphic overlay over the video images of said second video output.

20. The vision system of claim 18, wherein said dark display signal is generated via a low-power mode of said second camera.
